(19) United States
(12) Patent Application Publication
(10) Pub. No.: US 2002/0148578 A1
(43) Pub. Date: Oct. 17, 2002

(54) Device for applying an embossing to a web of tissue paper and method thereof

(76) Inventors: Ian Reilly, Cheshire (GB); Keith Littlewood, Wigan (GB)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/107,216

(22) Filed: Mar. 28, 2002

Related U.S. Application Data
(60) Provisional application No. 60/279,657, filed on Mar. 30, 2001.

(51) Int. Cl. B31F 1/07; B44B 5/00

(52) U.S. Cl. 162/109; 162/362; 101/32; 101/5; 101/23

(57) ABSTRACT

A device for applying an embossing to a web of tissue paper (12) comprises a full width anvil roller (14) and a plurality of small widths embossing rollers (16) which are rotationally movable around rotational axes which run parallel to the rotational axis of the anvil roller. The embossing rollers (16) have a width which is substantially smaller than the width of the anvil roller (14) and can be individually positioned against the anvil roller.

### CROSS-REFERENCE TO RELATED APPLICATIONS

The present application claims the priority of U.S. Provisional Application No. 60/279,657, filed in the U.S. on Mar. 30, 2001, the entire contents of which is hereby incorporated herein by reference.

### FIELD OF THE INVENTION

The invention relates to a device for applying an embossing pattern to a web of tissue paper and a method of applying embossing with ply bonding to a tissue paper web.

### DESCRIPTION OF THE RELATED ART

There is a number of ways of applying an embossing pattern to tissue paper. The most common are point to point, structured embossing or double embossing random laminate. In each of these cases, the embossing pattern is applied by use of one or more steel rollers in combination with rubber rollers. The rubber rollers have a yielding surface. A raised embossing pattern on the steel roller elastically presses into the rubber roller so that the tissue paper fed between the rubber roller and the steel roller is imparted an embossing pattern into the sheet. Both sheets are thus embossed and are normally clued together. Alternatively, it is possible to emboss both plies of tissue paper together. In the latter case, it is necessary to use adhesive as the bonding agent.

Embossing rollers are quite expensive. If there are several individual embossing designs which should be used in a batch-wise manner, one needs to keep several sets of expensive rollers, moreover, on wide width machines, the embossing rollers can have a weight of several tons in order to try to overcome the bending pressure of the roller at high speed. Therefore, it takes a considerable time in the range of several working days in order to change each set of roller. Moreover, despite of the weight of the embossing rollers of several tons, a flexing of the rollers can often not be avoided and hence uneven pressure of the embossment and lamination. This compromises the outer appearance of the embossed product. Finally, if part of the roller gets damaged, it is necessary to replace the full roller.

### SUMMARY OF THE INVENTION

It is the object of the invention to provide a device for applying an embossing to a web of tissue paper which improves the evenness of the embossment in the product and reduces down time when changing the roller.

This object is solved by a device for applying an embossing to a web of tissue paper with the features of claim 1 and a method of applying embossing with ply bonding to a tissue paper web with the features of claim 11.

It is the general concept of the invention to combine a full width anvil roller and a plurality of small width embossing rollers to form an embossing unit. Each of the plurality of small width embossing rollers is rotationally movable around a rotational axis which runs parallel to a rotational axis of the anvil roller. The embossing rollers have a width which is substantially smaller than that of the anvil roller. Therefore, instead of using a big size embossing roller, a plurality of small size rollers is used. These small size rollers have a considerably smaller weight which facilitates the handling of the individual rollers. Finally, each embossing roller can be individually positioned against the anvil roller. This allows to compensate for flexing of the anvil roller and for wear of the anvil roller or each individual embossing roller. This opens up the possibility to obtain a product with a high evenness of the embossment regardless the position of the embossing roller relative to the width of the anvil roller.

Moreover, the embossing rollers can be provided with a raised embossing pattern and with a series of teeth cut into the embossing pattern. With this configuration it is possible to apply a decorative embossing and aply-bonding to a tissue paper web at the same time. The aforementioned possibility to individually position each embossing roller against the anvil roller also makes it possible to obtain over the whole width of the web a ply bonding quality of the tissue paper web which is within small manufacturing tolerances.

Preferred embodiments of the invention are described in the dependent claims.

According to a preferred embodiment, the embossing pattern further comprises a series of teeth cut into them so that by use of a pressure, the two plies of tissue paper are mechanically bonded together. In that case, the inventive device serves a double function namely to apply an embossing and produce ply bonding to the tissue paper substrate.

Preferably, the anvil roller is at least partially coated with a material with a rubber hardness between 90 and 95 shore-A. This rubber hardness has been found to achieve excellent results in combination with steel embossing rollers.

In a preferred embodiment, the embossing rollers are positioned side-by-side with a small gap in between and are suspended by a girder fixed to the machine frame of the device. The embossing rollers with the small gap in between act like a full width roller with the above discussed advantages as regards the improved product quality and handling of the embossing rollers. Moreover, they can be fixed in line to a common element of the machine frame. By suspending the embossing roller units by a girder fixed to the machine frame of the device, the fixation of the embossing roller units is easy accessible in order to exchange individual embossing roller units.

To this end, it has been found to be advantageous that the embossing rollers are held by brackets hooked into the girder. When changing embossing rollers, an embossing roller unit consisting of the embossing roller and the bracket can easily be removed from the girder and a replacement embossing roller unit is then hooked into the girder. Additionally, a locking device could be provided for fixing the bracket of an individual embossing roller unit to the girder.

According to a preferred embodiment, each of the embossing rollers cooperates with the device for pressing the embossing roller with a predetermined pressure against the anvil roller. This is the easiest way to ensure that the embossing of the tissue paper substrate is as even as possible over the width of the web.

A predetermined pressure can be achieved by providing a hydraulically or pneumatically expandable positioning means. This positioning means exerts a predetermined pressure force on each embossing roller so that each embossing roller presses with a predetermined force against the anvil roller.

According to a preferred embodiment, the device further comprises a pressure limiting means in order to preset a minimum pressure between each embossing roller and the anvil roller. This measure serves to ensure a sufficient embossing effect or ply bonding under all possible working conditions of the pressure device. This minimum pressure is also exerted in case that the device for pressing fails.

### BRIEF DESCRIPTION OF THE DRAWINGS

In the following, a preferred embodiment of the invention will be described with reference to the accompanying drawings, in which:

FIG. 1 is a schematic view of a preferred embodiment of the inventive embossing device;

FIG. 2 represents a sectional side view of a single embossing roller unit fixed to the machine frame and cooperating with a anvil roller; and

FIG. 3 represents a view of an operation panel in order to simplify a possible operation of a pressure device of the embossing device.

### SUMMARY OF THE INVENTION

It is the object of the invention to provide a device for applying an embossing to a web of tissue paper which improves the evenness of the embossment in the product and reduces down time when changing the roller.

This object is solved by a device for applying an embossing to a web of tissue paper with the features of claim 1 and a method of applying embossing with ply bonding to a tissue paper web with the features of claim 11.

It is the general concept of the invention to combine a full width anvil roller and a plurality of small width embossing rollers to form an embossing unit. Each of the plurality of small width embossing rollers is rotationally movable around a rotational axis which runs parallel to a rotational axis of the anvil roller. The embossing rollers have a width which is substantially smaller than that of the anvil roller. Therefore, instead of using a big size embossing roller, a plurality of small size rollers is used. These small size rollers have a considerably smaller weight which facilitates the handling of the individual rollers. Finally, each embossing roller can be individually positioned against the anvil roller. This allows to compensate for flexing of the anvil roller and for wear of the anvil roller or each individual embossing roller. This opens up the possibility to obtain a product with a high evenness of the embossment regardless the position of the embossing roller relative to the width of the anvil roller.

Moreover, the embossing rollers can be provided with a raised embossing pattern and with a series of teeth cut into the embossing pattern. With this configuration it is possible to apply a decorative embossing and aply-bonding to a tissue paper web at the same time. The aforementioned possibility to individually position each embossing roller against the anvil roller also makes it possible to obtain over the whole width of the web a ply bonding quality of the tissue paper web which is within small manufacturing tolerances.

Preferred embodiments of the invention are described in the dependent claims.

According to a preferred embodiment, the embossing pattern further comprises a series of teeth cut into them so that by use of a pressure, the two plies of tissue paper are mechanically bonded together. In that case, the inventive device serves a double function namely to apply an embossing and produce ply bonding to the tissue paper substrate.

Preferably, the anvil roller is at least partially coated with a material with a rubber hardness between 90 and 95 shore-A. This rubber hardness has been found to achieve excellent results in combination with steel embossing rollers.

In a preferred embodiment, the embossing rollers are positioned side-by-side with a small gap in between and are suspended by a girder fixed to the machine frame of the device. The embossing rollers with the small gap in between act like a full width roller with the above discussed advantages as regards the improved product quality and handling of the embossing rollers. Moreover, they can be fixed in line to a common element of the machine frame. By suspending the embossing roller units by a girder fixed to the machine frame of the device, the fixation of the embossing roller units is easy accessible in order to exchange individual embossing roller units.

To this end, it has been found to be advantageous that the embossing rollers are held by brackets hooked into the girder. When changing embossing rollers, an embossing roller unit consisting of the embossing roller and the bracket can easily be removed from the girder and a replacement embossing roller unit is then hooked into the girder. Additionally, a locking device could be provided for fixing the bracket of an individual embossing roller unit to the girder.

According to a preferred embodiment, each of the embossing rollers cooperates with the device for pressing the embossing roller with a predetermined pressure against the anvil roller. This is the easiest way to ensure that the embossing of the tissue paper substrate is as even as possible over the width of the web.

A predetermined pressure can be achieved by providing a hydraulically or pneumatically expandable positioning means. This positioning means exerts a predetermined pressure force on each embossing roller so that each embossing roller presses with a predetermined force against the anvil roller.

According to a preferred embodiment, the device further comprises a pressure limiting means in order to preset a minimum pressure between each embossing roller and the anvil roller. This measure serves to ensure a sufficient embossing effect or ply bonding under all possible working conditions of the pressure device. This minimum pressure is also exerted in case that the device for pressing fails.

### BRIEF DESCRIPTION OF THE DRAWING FIGURES

In the following, a preferred embodiment of the invention will be described with reference to the accompanying drawings, in which:

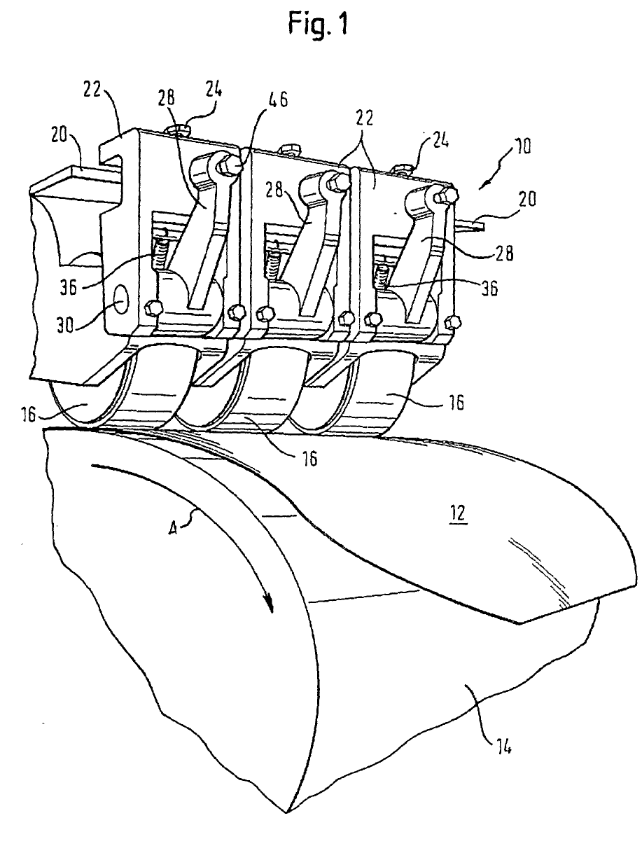

FIG. 1 is a schematic view of a preferred embodiment of the inventive embossing device;

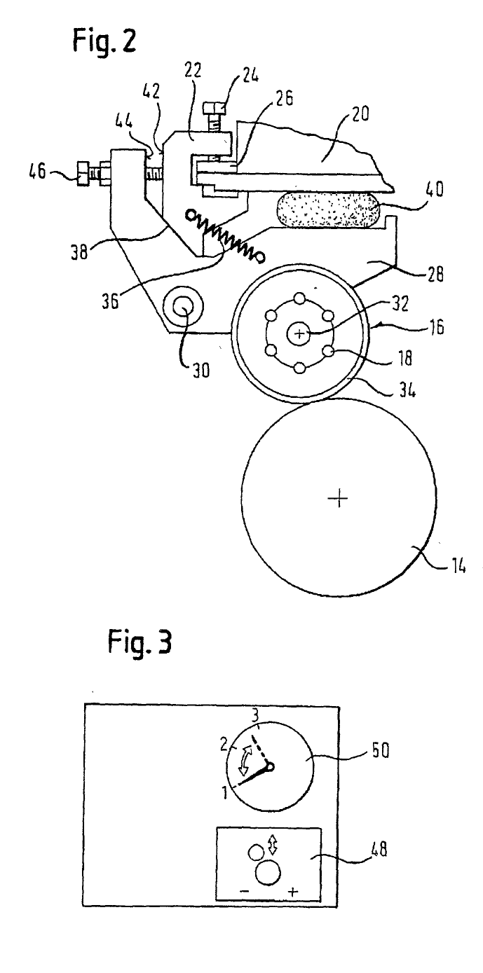

FIG. 2 represents a sectional side view of a single embossing roller unit fixed to the machine frame and cooperating with a anvil roller; and

FIG. 3 represents a view of an operation panel in order to simplify a possible operation of a pressure device of the embossing device.

### DETAILED DESCRIPTION OF THE INVENTION

In the following description, identical or similar elements will be designated throughout the figs. with the same reference numerals.

FIG. 1 gives a schematic, three dimensional view of the inventive device 10. A tissue web 12 passes between an anvil roller 14 rotated in rotational direction A and a plurality of embossing rollers 16 which run against the anvil roller 14. The anvil roller is covered with rubber of a rubber hardness between 90 and 95 shore A hardness. As a possible rubber material, hypaloy rubber can be used. The anvil roller is mounted above the machine on two bearings located in the end frames of the machine.

The embossing roller units are mounted above the anvil roller 14 so that they are in contact with it. The mounting of the embossing rollers will be discussed in more detail below. As can bee seen from FIG. 1, there are three anvil roller units mounted above the anvil roller 14. However, the number of embossing rollers according to FIG. 1 is only an example and a different number of embossing roller units can be used.

The embossing roller units consist of small steel rollers 16 which are engraved with the design to be embossed. Moreover, the raised embossed pattern can have a series of teeth cut into them so that by applying pressure between the embossing rollers 16 and the anvil roller 14, two plies of tissue web material can be mechanically bonded together.

The embossing rollers run on bearings 18 as can be best seen from FIG. 2.

As can be seen from FIGS. 1 and 2, the embossing roller unit comprises a bracket 22 which serves to mount the unit to a girder 20 of the machine frame. Moreover, there is a locking screw 24 cooperating with a locking plate 26 in order to fix the embossing roller unit once hooked into the flange of the girder 20 in place. Moreover, the embossing roller unit comprises a frame element 28 which is pivotally attached to bracket 22 via a pivot pin 30 and holds the shaft 32 of the embossing roller 16. The embossing roller 16 further comprises a knurled wheel 34 on which the raised embossing pattern and, optionally, teeth are provided on its circumferential surface.

As mentioned above, the bracket 32 is pivotally mounted to the frame element 28 via a pivot pin 30. In order to define the position of the bracket relative to the frame element, a tension spring 36 is provided between the frame element 28 and the bracket 22. Moreover, the frame element 28 and the bracket 22 have slanted surfaces 38 which cooperate together to allow an exact positioning of the embossing roller 16 relative to the anvil roller 14.

Each embossing roller unit can be hydraulically controlled as to adjust pressure to each individual unit. This is achieved by means of an expandable means 40 which, for easy illustrative purposes, is depicted as a tube or cushion in FIG. 2. Increasing the pressure inside the cushion 40 forces the frame element 28 to move away from the girder 20 so that the embossing roller 16 moves towards the anvil roller 14. If the embossing roller 16 is already in abutting contact with the anvil roller 14, the pressure within the cushion 40 corresponds to the pressure exerted by the embossing roller 16 on the anvil roller 14.

If the cushion 40 expands, the bracket 22 rides down the slanted surface 38 of the frame element 28 so that the distance between a first surface 42 on the bracket 22 which is facing towards a second surface 42 on the frame element 28 increases. This effect is used to preset a minimum pressure exerted by the embossing roller 16 on the anvil roller 14. Even in case of a failing of the cushion 40 due to a failing of the hydraulic or pneumatic system feeding the pressure in the cushion 40, the pressure cannot fall short of a minimum pressure. This minimum pressure is predetermined by adjustment the pressure adjusting screw 46 by which a minimum distance between the first surface 42 and second surface 44 is always maintained.

In operation, a user sets on a suitable operation panel 48 the pressure gauge to e.g. 1 bar and then brings the pressure adjusting screw up by hand until hand tight. Then, the pressure adjusting screw can be locked in that position. Once running, a recommended pressure setting can be set. Under normal operating conditions, this recommended pressure setting could be between 1 bar and 2.5 bar which the operator can read from the manometer display 50. Therefore, the pressure adjusting screw is used to preset a setting pressure, whereas the running pressure is achieved via the pneumatic or hydraulic pressure system feeding the cushion 40.

Each embossing roller has normally, but not exclusively, two product roll widths. The brackets of each neighbouring embossing roller unit abut each other so as to minimize the gap between each embossing roller imprint. Typically, there will be a 30 mm gap between each emboss roller. Each embossing roller unit is on a flexible mount which can move laterally so as to accommodate uneven wear in the roller surface. Each unit can be hydraulically or pneumatically controlled so as to adjust pressure to each individual unit. This means that wear and anvil roller flexing can be compensated for easily.

The embossing technique utilises an existing system of ply bonding wheels. These are mounted on the machine between the normal emboss section and the perforation head.

Instead of having a large steel embossing roller, there are several small steel rollers engraved with the desired embossing design. Each roller can be hydraulically or pneumatically placed against the anvil roller at bearing pressures so as to follow any bending contours of the anvil roll when running at speed. This results in a uniform emboss distributed evenly across the web. It is possible to exchange the individual embossing roller units so that a multitude of different embossing patterns can be applied across a single tissue web. Further, it is possible to put a patterned embossing design on either flat tissue substrate or on previously embossed tissue substrate. Moreover, when using a raised embossing pattern with a series of teeth, the two plies are mechanically bonded together at the same time.

If one small roller becomes worn or becomes damaged, then it can be easily and cheaply replaced. When changing and setting up the edge embossing units, the pressure in the pneumatic tube is released and the locking screw and pressure adjusting screw are loosened so that the brackets can be easily lifted out of the attachment flange of the girder. Then, a replacement unit is hooked onto the flange of the girder and locked in place by means of the locking screw and the locking plate correctly fitted und the locking screw. Then, the pressure is set to the predetermined setting pressure and the adjusting screw is tightened until hand tight and then locked. Then, the embossing roller unit can be pressurised again and is ready for use.

The inventive device provides a considerable number of key savings. The set of rollers can be supplied at a lower price and, if a roller is damaged, then just one small roller has to be replaced. Moreover, the exchange of rollers either in case of damage or in case of changing the desired embossing pattern requires a considerably shorter down time. Finally, the provision if individual embossing roller units can accommodate uneven wear in the roller surface so that the frequency of occurrence of down times is further reduced.

The inventive device provides a high product quality due to a small tolerance of a preset pressure between each embossing roller and the anvil roller. This contributes to improve the product quality, especially with respect to a decorative embossing, and to minimize rejects.

What is claimed is:

1. A device for applying an embossing to a web of tissue paper, comprising:
a full width anvil roller; and
a plurality of small width embossing rollers which are rotationally movable around rotational axes which run parallel to a rotational axis of the anvil roller;
wherein each embossing roller has a width which is substantially smaller than the width of the anvil roller; and
each embossing roller can be individually positioned against the anvil roller.

2. The device according to claim 1, wherein the embossing rollers have a raised embossing pattern on their circumferential surface.

3. The device according to claim 2, the embossing pattern further comprising a series of teeth cut into them.

4. The device according to claim 1, wherein the anvil roller is at least partially coated with a material with a rubber hardness between 90 and 95 shore A.

5. The device according to claim 1, wherein the embossing rollers are positioned side-by-side with a small gap in between and are suspended by a girder fixed to the machine frame of the device.

6. The device according to claim 5, wherein the embossing rollers are held by brackets hooked into the girder.

7. The device according to claim 1, wherein each of the embossing rollers cooperates with a device for pressing the embossing roller with a predetermined pressure against the anvil roller.

8. The device according to claim 7, wherein the device for pressing comprises a pneumatically or hydraulically expandable positioning means.

9. The device according to claim 7, further comprising means for presetting a minimum pressure between each embossing roller and the anvil roller.

10. A method of changing embossing rollers in a device according to claim 6, the method comprising:
unlocking a locking device between the bracket of an individual embossing roller unit and the girder of the machine frame;
removing the embossing roller unit;
hooking a replacement embossing roller unit into the girder of the machine frame; and
locking the bracket of the replacement embossing roller unit to the girder.

11. A method of applying embossing with ply bonding to a tissue paper web, the method comprising:
combining two plies of tissue web;
passing the combined tissue web between a full width anvil roller and a set of small width steel embossing rollers with a raised embossing pattern and with a series of teeth cut into the embossing pattern;
wherein the small width steel embossing rollers are pressed with a predetermined pressure against the anvil roller.
